(19) United States
(12) Patent Application Publication
(10) Pub. No.: US 2025/0096500 A1
(43) Pub. Date: Mar. 20, 2025

(54) CONNECTOR

(71) Applicant: JAPAN AVIATION ELECTRONICS INDUSTRY, LIMITED, Tokyo (JP)

(72) Inventors: Atsushi KOBAYASHI, Tokyo (JP); Takashi OMODACHI, Tokyo (JP)

(73) Assignee: JAPAN AVIATION ELECTRONICS INDUSTRY, LIMITED, Tokyo (JP)

(21) Appl. No.: 18/829,123

(22) Filed: Sep. 9, 2024

Related U.S. Application Data
(60) Provisional application No. 63/538,361, filed on Sep. 14, 2023.

(30) Foreign Application Priority Data
Mar. 6, 2024 (JP) 2024-034381

(51) Int. Cl. H01R 13/422; H01R 12/71

(52) U.S. Cl. CPC H01R 13/422; H01R 12/716

(57) ABSTRACT

The connector comprises terminals arranged along a pitch direction and a housing. Each of the terminals has a fixed portion configured to be fixed to a board, a held portion extending from the fixed portion and a spring portion extending from the held portion. The fixed portions of adjacent two of the terminals in the pitch direction are located at positions different from each other in a lateral direction perpendicular to the pitch direction. The housing is formed with holding portions which hold the held portions of the terminals, respectively, and accommodation portions which accommodate the spring portions of the terminals, respectively. The holding portion which holds the held portion of one of the adjacent two of the terminals does not overlap with the accommodation portion which accommodates the spring portion of a remaining one of the adjacent two of the terminals in the lateral direction.

### CROSS REFERENCE TO RELATED APPLICATIONS

This application is based on and claims priority under 35 U.S.C. § 119 to Japanese Patent Application No. JP 2024-034381 filed Mar. 6, 2024, and U.S. Provisional Patent Application No. 63/538,361 filed Sep. 14, 2023, the contents of which are incorporated herein in their entireties by reference.

### BACKGROUND OF THE INVENTION

This invention relates to a connector configured to be mounted on a board.

For example, this type of connector is disclosed in JP2023-110817A (Patent Document 1), the content of which is incorporated herein by reference.

Referring to FIG. 13, Patent Document 1 discloses a connector 90 which is a so-called on-board connector configured to be mounted on a board (not shown). The connector 90 comprises a housing 92 made of resin and terminals 94 held by the housing 92. The terminals 94 form two terminal rows each extending along a pitch direction (Y-direction). The terminals 94 of each of the terminal rows include first terminals 96 and second terminals 98. Each of the second terminals 98 has a shape of the first terminal 96 which is rotated by 180 degrees about an axis extending in parallel to an up-down direction (Z-direction). The first terminals 96 and the second terminals 98 of each of the terminal rows are alternately arranged. According to the aforementioned alternate arrangement (staggered arrangement), a distance between two of the terminals 94 which are adjacent each other in the pitch direction can be made short. Thus, the terminals 94 can be arranged in a narrow pitch, and thereby a size of the connector 90 in the pitch direction can be reduced.

There is a demand to further reduce a size of a connector in a pitch direction.

### SUMMARY OF THE INVENTION

It is therefore an object of the present invention to provide a connector with a structure which enables terminals to be arranged in a narrower pitch.

An aspect of the present invention provides a connector configured to be mounted on a board. The connector comprises terminals and a housing. Each of the terminals has a fixed portion, a held portion, a spring portion and a contact point. The fixed portion is configured to be fixed to the board. The held portion extends from the fixed portion. The spring portion extends from the held portion. The contact point is supported by the spring portion. The terminals are arranged along a pitch direction. The fixed portions of adjacent two of the terminals which are adjacent to each other in the pitch direction are located at positions different from each other in a lateral direction perpendicular to the pitch direction. The housing is formed with holding portions which correspond to the terminals, respectively, and accommodation portions which correspond to the terminals, respectively. Each of the holding portions holds the held portion of a corresponding one of the terminals. Each of the accommodation portions accommodates the spring portion of a corresponding one of the terminals. The accommodation portions are arranged along the pitch direction. Two of the accommodation portions which are adjacent to each other in the pitch direction are formed with a partition wall located therebetween. The holding portion which holds the held portion of one of the adjacent two of the terminals does not overlap with the accommodation portion which accommodates the spring portion of a remaining one of the adjacent two of the terminals in the lateral direction.

According to an aspect of the present invention, the fixed portions of a first terminal and a second terminal, which are two of the terminals adjacent to each other in the pitch direction, are located at positions different from each other in the lateral direction. In other words, the terminals of an aspect of the present invention are staggered-arranged, and thereby the terminals can be arranged in a narrow pitch. Moreover, the holding portion which holds the held portion of the first terminal and the accommodation portion which accommodates the spring portion of the second terminal are apart from each other so that they do not overlap with each other in the lateral direction. According to this structure, the partition wall located between two of the accommodation portions can be formed sufficiently thick even when the pitch between the terminals is made narrower, and thereby the housing can be prevented from being degraded in strength. Thus, an aspect of the present invention provides a connector with a structure which enables terminals to be arranged in a narrower pitch.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector according to an embodiment of the present invention, wherein a part of the connector enclosed by dashed line is enlarged and illustrated.

FIG. 2 is a top view showing the connector of FIG. 1.

FIG. 3 is a side view showing the connector of FIG. 1 together with a mating connector, wherein an outline of an upper surface of a board on which the connector is mounted and another outline of a lower surface of a mating board on which the mating connector is mounted are illustrated with dashed line.

FIG. 4 is a bottom view showing the connector of FIG. 1, wherein a middle part of the connector in a pitch direction is not illustrated.

FIG. 5 is an enlarged, bottom view showing a part of the connector of FIG. 4 enclosed by dashed line A, wherein outlines of terminals are illustrated with chain dotted line.

FIG. 6 is a perspective view showing the mating connector of FIG. 3.

FIG. 7 is a cross-sectional view showing the connector of FIG. 2, taken along line VII-VII, wherein outlines of holding portions each of which holds a second terminal adjacent to the illustrated first terminal in the pitch direction are illustrated with dashed line.

FIG. 8 is a cross-sectional view showing the connector of FIG. 2, taken along line VIII-VIII, wherein outlines of the holding portion each of which holds the first terminal adjacent to the illustrated second terminal in the pitch direction are illustrated with dashed line.

FIG. 9 is a perspective view showing the first terminal of FIG. 7.

FIG. 10 is a side view showing the first terminal of FIG. 9, wherein an outline of an accommodation portion of a housing is illustrated with dashed line.

FIG. 11 is a top view showing the first terminal of FIG. 9.

FIG. 12 is a side view showing the second terminal of FIG. 8.

FIG. 13 is a perspective view showing a connector of Patent Document 1, wherein a part of the connector enclosed by dashed line is enlarged and illustrated.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

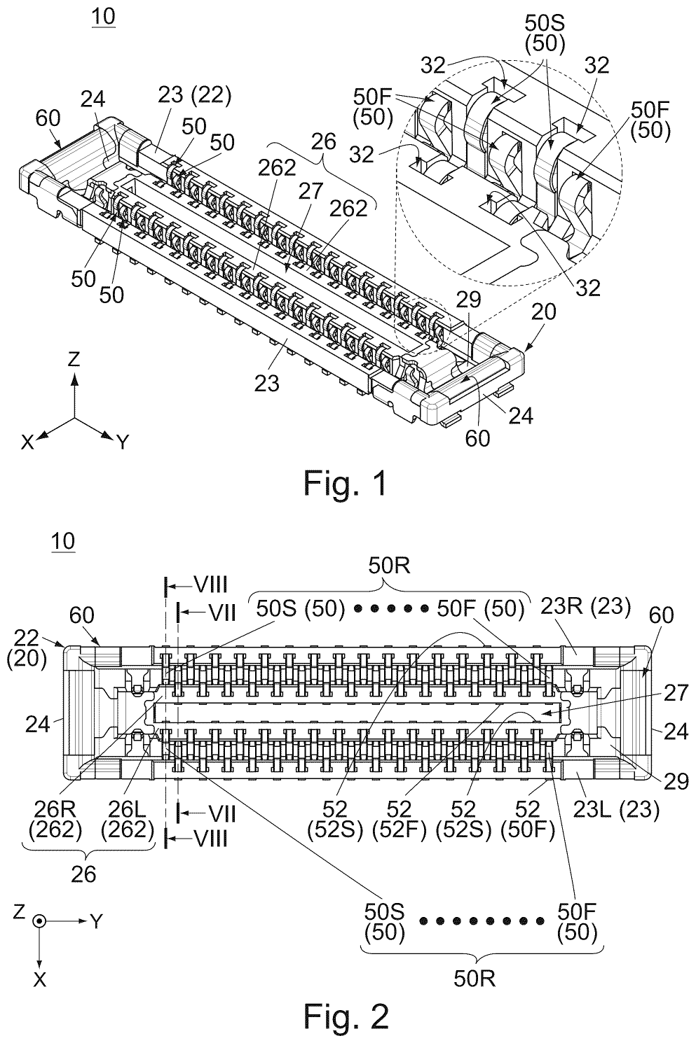

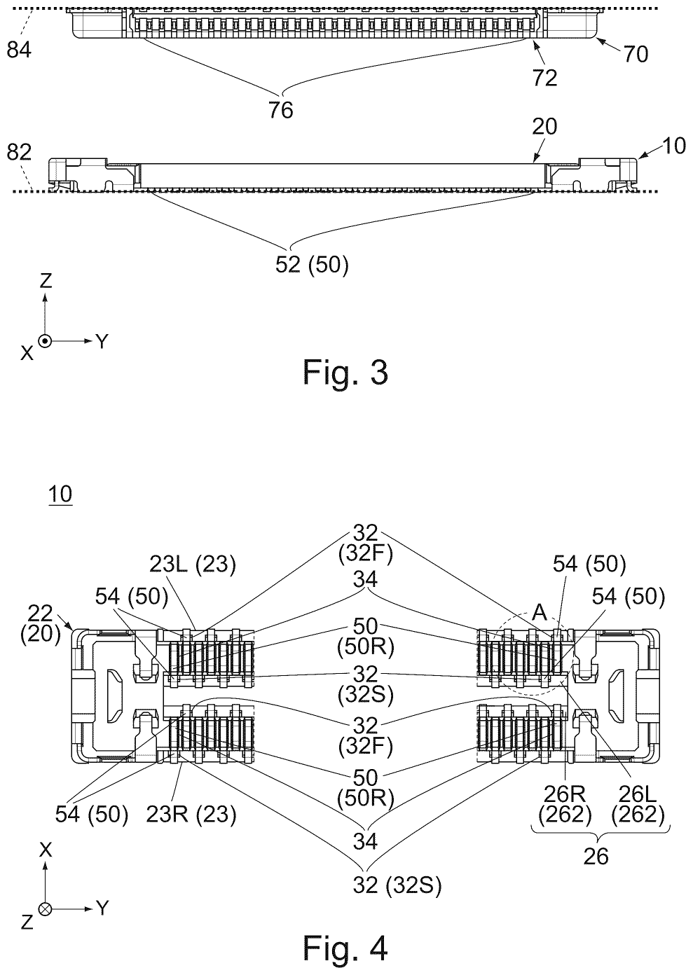

Referring to FIG. 1 together with FIG. 3, a connector 10 according to an embodiment of the present invention is an on-board connector configured to be mounted on a board 82. The connector 10 is mateable with a mating connector 70, which is mounted on a mating board 84, along an up-down direction. The up-down direction of the present embodiment is the Z-direction. In the present embodiment, “upward” means the positive Z-direction, and “downward” means the negative Z-direction. The words such as the up-down direction do not indicate the absolute positional relation relative to the ground but merely indicate a relative positional relation in figures.

Referring to FIGS. 1 and 2, the connector 10 of the present embodiment comprises a housing 20 made of insulator, terminals 50 each made of conductor and two hold-downs 60 each made of conductor. The hold-downs 60 are attached to opposite ends of the housing 20 in a pitch direction perpendicular to the up-down direction, respectively, and reinforce the housing 20. The pitch direction of the present embodiment is the Y-direction. The connector 10 of the present embodiment comprises only the aforementioned members. However, the present invention is not limited thereto. For example, the connector 10 may comprise another member in addition to the aforementioned members. The hold-downs 60 may be provided as necessary.

Hereafter, explanation will be made about the mating connector 70 (see FIG. 6) of the present embodiment.

Referring to FIG. 6, the mating connector 70 of the present embodiment comprises a mating housing 72 made of insulator, mating terminals 76 each made of conductor and two mating hold-downs 78 each made of conductor. The mating hold-downs 78 are attached to opposite ends of the mating housing 72 in the pitch direction, respectively, and reinforce the mating housing 72.

Referring to FIG. 3, the mating terminals 76 are provided so as to correspond to the terminals 50, respectively. Each of the terminals 50 is brought into contact with the corresponding mating terminal 76 under a mated state where the connector 10 and the mating connector 70 are mated with each other, and thereby the board 82 and the mating board 84 are electrically connected with each other. The mating connector 70 of the present embodiment has the aforementioned structure. However, the structure of the mating connector 70 of the present invention is not specifically limited.

Hereafter, explanation will be made about a basic structure of the housing 20 of the present embodiment.

Referring to FIGS. 1 and 2, the housing 20 of the present embodiment is a unitary member molded of resin and has a peripheral wall 22, an island-like portion 26 and a bottom portion 29. The peripheral wall 22 has two long walls 23 and two short walls 24. Thus, the housing 20 has the two long walls 23 and the two short walls 24.

Each of the long walls 23 of the present embodiment extends along the pitch direction. Each of the short walls 24 of the present embodiment extends along a lateral direction perpendicular to both the up-down direction and the pitch direction and couples the two long walls 23 together in the lateral direction. The lateral direction of the present embodiment is the X-direction. In the present embodiment, “left-side” means the positive X-side, and “right-side” means the negative X-side. The long wall 23 has a size in the pitch direction which is larger than another size of the short wall 24 in the lateral direction. In other words, the long wall 23 is longer than the short wall 24.

The peripheral wall 22 of the present embodiment is formed of the long walls 23 and the short walls 24 and has a rectangular, seamless frame-shape in a horizontal plane (XY-plane) defined by the pitch direction and the lateral direction. However, the present invention is not limited thereto. For example, the structure of the peripheral wall 22 can be modified as necessary.

As shown in FIG. 1, the island-like portion 26 of the present embodiment is enclosed by the long walls 23 and the short walls 24 in the horizontal plane and extends along the pitch direction. The island-like portion 26 is formed with a middle hole 27. The middle hole 27 is located at the middle of the island-like portion 26 in the lateral direction. The middle hole 27 extends along the pitch direction and passes through the island-like portion 26 in the up-down direction. As a result, the island-like portion 26 is formed with two side walls 262. The two side walls 262 are located at opposite sides of the middle hole 27 in the lateral direction, respectively, and extend along the pitch direction. The island-like portion 26 of the present embodiment has the aforementioned structure. However, the present invention is not limited thereto. For example, the middle hole 27 may be formed as necessary. The island-like portion 26 may be provided as necessary.

Referring to FIG. 2, the two long walls 23 of the present embodiment consist of a right long wall 23R and a left long wall 23L. The two side walls 262 of the island-like portion 26 of the present embodiment consist of a right-side wall 26R and a left-side wall 26L. The right long wall 23R and the right-side wall 26R face each other in the lateral direction. The left long wall 23L and the left-side wall 26L face each other in the lateral direction.

Referring to FIGS. 1 and 2, the bottom portion 29 of the present embodiment is located at a lower side of the housing 20. The island-like portion 26 is coupled to each of the long walls 23 and the short walls 24 via the bottom portion 29. However, the present invention is not limited thereto. For example, the island-like portion 26 may be coupled to only the short walls 24 via the bottom portion 29.

Hereafter, explanation will be made about the terminals 50 of the present embodiment.

The terminals 50 of the present embodiment include first terminals 50F and second terminals 50S. As can be seen from FIGS. 10 and 12, the second terminal 50S has a shape of the first terminal 50F which is rotated by 180 degrees about an axis extending in parallel to the up-down direction. Thus, the first terminal 50F and the second terminal 50S are components same as each other although their arranged postures are different from each other. However, the present invention is not limited thereto. For example, the first terminal 50F and the second terminal 50S may have structures different from each other.

Hereafter, explanation will be made about a structure of one of the terminals 50, or one of the first terminals 50F, of the present embodiment. The explanation described blow is applicable to each of the terminals 50 including the second terminals 50S.

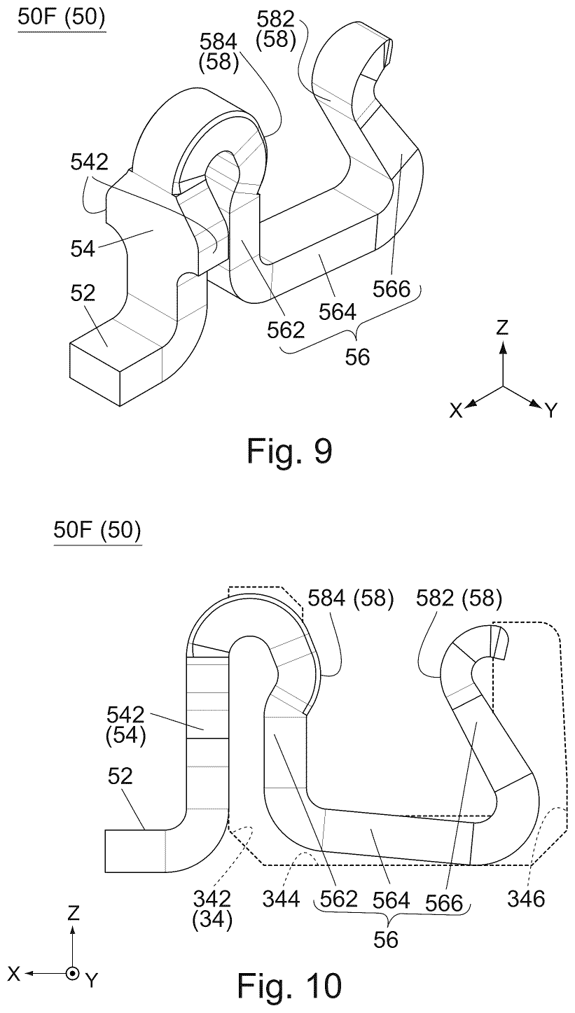

Referring to FIGS. 9 and 10, the terminal 50 of the present embodiment is not a contact which is formed by merely cutting a single metal plate but is a contact which is formed by bending a single metal plate. Hereafter, this contact is referred to as “bent contact”. Thus, the terminal 50 is a single metal plate with bends. The terminal 50 of the present embodiment has a fixed portion 52, a held portion 54, a spring portion 56 and two contact points 58.

Referring to FIG. 3, the terminal 50 of the present embodiment is configured to be surface-mounted on the board 82. More specifically, the fixed portion 52 of the present embodiment is configured to be fixed on the board 82 via soldering. As shown in FIG. 9, the fixed portion 52 of the present embodiment has a rectangular flat-plate shape. However, the present invention is not limited thereto. For example, the fixing method of the fixed portion 52 to the board 82 (see FIG. 3) is not specifically limited.

As shown in FIGS. 9 and 10, the held portion 54 of the present embodiment extends from the fixed portion 52. In detail, the held portion 54 extends upward in an arc from one of opposite edges of the fixed portion 52 in the lateral direction and then extends straight upward. The held portion 54 is provided with two press-fit projections 542. The press-fit projections 542 project from opposite sides of the held portion 54 in the pitch direction, respectively. The held portion 54 of the present embodiment has the aforementioned structure. However, the structure of the held portion 54 of the present invention is not specifically limited, provided that the held portion 54 is provided with parts which project from opposite sides thereof in the pitch direction.

The spring portion 56 extends from the held portion 54. In detail, the spring portion 56 of the present embodiment has a downward extending portion 562, a bottom portion 564 and an upward extending portion 566. The downward extending portion 562 extends in an arc from an upper end of the held portion 54 so as to be away from the fixed portion 52 in the lateral direction and then extends downward. The bottom portion 564 extends from a lower end of the downward extending portion 562 along the lateral direction while being away from the held portion 54. The upward extending portion 566 extends upward from one of opposite ends of the bottom portion 564 which is farther from the held portion 54.

The spring portion 56 of the present embodiment has the aforementioned structure. The spring portion 56 of the present embodiment has a U-like shape as a whole and is easily deformed resiliently. However, the structure of the spring portion 56 of the present invention is not specifically limited, provided that the spring portion 56 has spring characteristics.

The contact points 58 are supported by the spring portion 56 and are movable in accordance with resilient deformation of the spring portion 56. In detail, one of the two contact points 58 of the present embodiment is a main contact point 582 provided on the upward extending portion 566. The main contact point 582 is movable in the lateral direction to a relatively large extent in accordance with the resilient deformation of the spring portion 56. A remaining one of the two contact points 58 is a sub-contact point 584 provided on the downward extending portion 562. The sub-contact point 584 is hardly moved even when the spring portion 56 is resiliently deformed. The contact points 58 of the present embodiment are provided as described above. However, the present invention is not limited thereto. For example, the number of the contact points 58 may be one.

Hereafter, explanation will be made about an arrangement of the terminals 50 of the present embodiment.

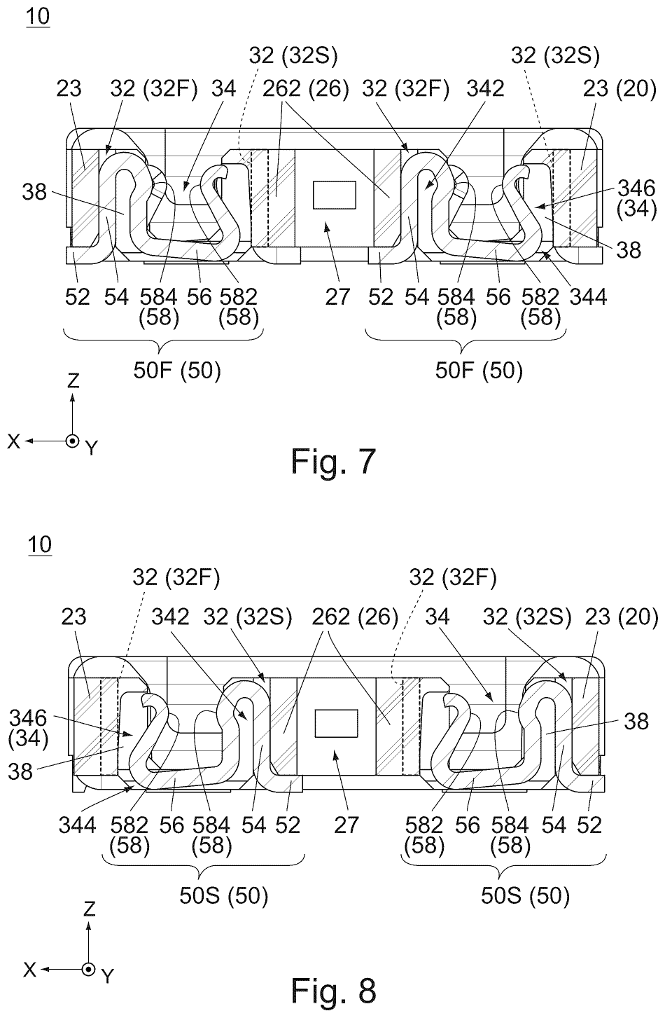

Referring to FIG. 2, the terminals 50 of the present embodiment are divided into two terminal rows 50R. The two terminal rows 50R consist of a right-side terminal row 50R which is located at the right-side of the housing 20 in the lateral direction and a left-side terminal row 50R which is located at the left-side of the housing 20 in the lateral direction. The terminals 50 of each of the terminal rows 50R are linearly arranged along the pitch direction. Each of the terminal rows 50R includes the first terminals 50F and the second terminals 50S. The first terminals 50F and the second terminals 50S of each of the terminal rows 50R are alternately arranged at regular intervals in the pitch direction. Referring to FIGS. 7 and 8, the first terminal 50F and the second terminal 50S are arranged so that the fixed portions 52 thereof face away from each other in the lateral direction.

As a result of the aforementioned arrangement, the fixed portions 52 of any adjacent two of the terminals 50 which are adjacent to each other in the pitch direction are located at positions different from each other in the lateral direction. More specifically, the fixed portion 52 of each of the first terminals 50F and the fixed portion 52 of each of the second terminals 50S of each of the terminal rows 50R (see FIG. 2) are located at a position different from each other in the lateral direction. In other words, the terminals 50 of the present embodiment are arranged in an alternate arrangement (staggered arrangement), and thereby the terminals 50 can be arranged in a narrow pitch.

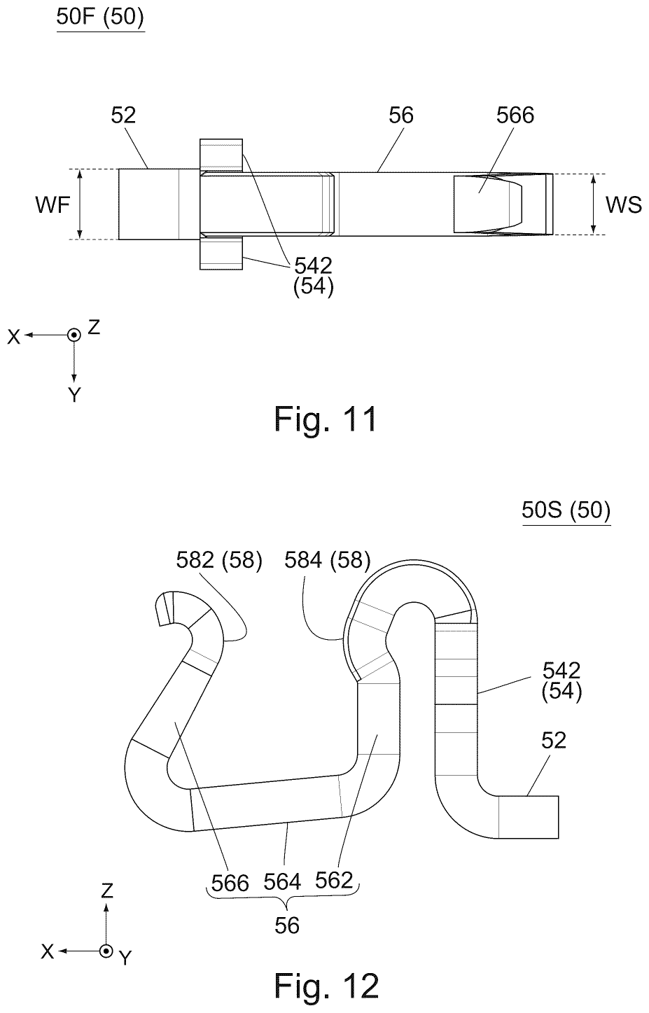

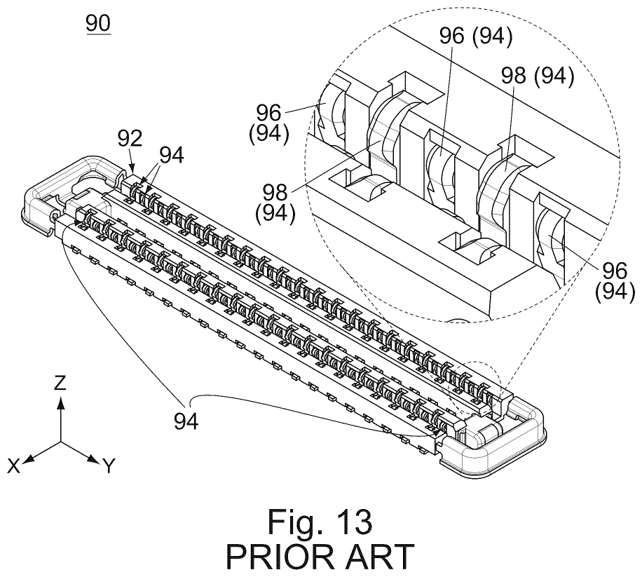

As shown in FIG. 11, the fixed portion 52 of each of the terminals 50 of the present embodiment has a size (width WF) in the pitch direction which is larger than another size (width WS) of the spring portion 56 in the pitch direction. According to the present embodiment, every part of the spring portion 56 has a size (width) in the pitch direction which is smaller than the width WF of the fixed portion 52. The width WS of the spring portion 56 is constant over all the spring portion 56 except for an upper part of the upward extending portion 566. The upper part of the upward extending portion 566 has a width which is equal to or less than the width WS.

According to the aforementioned structure, the pitch between the terminals 50 can be made small while the fixed portions 52 are securely fixed to the board 82 (see FIG. 3). Moreover, according to the present embodiment, the width WS can be easily made narrower than the width WF because each of the terminals 50 is a bent contact. However, the present invention is not limited thereto. For example, the width WF may be equal to the width WS.

Referring to FIG. 4, the housing 20 is formed with holding portions 32 which correspond to the terminals 50, respectively, and accommodation portions 34 which correspond to the terminals 50, respectively. Referring to FIGS. 7 and 8, each of the holding portions 32 and the accommodation portions 34 is a space which opens upward and downward from the housing 20. Each of the terminals 50 of the present embodiment is inserted into the corresponding holding portion 32 and the corresponding accommodation portion 34 from below.

In detail, referring to FIGS. 7 and 8 together with FIG. 10, the held portion 54 of each of the terminals 50 is press-fit into the corresponding holding portion 32 from below and thereby securely held. Thus, each of the holding portions 32 holds the held portion 54 of the corresponding terminal 50.

Each of the terminals 50 may be held by the holding portion 32 not by press-fitting the held portion 54 but by insert-molding the held portion 54 which has a retaining projection. However, according to this instance, the spring portion 56 of the terminal 50 should be covered by a die located therearound during the insert-molding so that the spring portion 56 is not buried in resin. As a result, an unnecessary large space is formed around the spring portion 56, and thereby the pitch between the terminals 50 might be widened. Therefore, the present embodiment is preferable from a viewpoint of arranging the terminals 50 in a narrow pitch.

The spring portion 56 of each of the terminals 50 is received in the corresponding accommodation portion 34 when the held portion 54 is press-fit into the holding portion 32. Thus, each of the accommodation portions 34 accommodates the spring portion 56 of the corresponding terminal 50. In detail, each of the accommodation portions 34 has a receiving portion 342, a groove 344 and a margin portion 346. The downward extending portion 562, the bottom portion 564 and the upward extending portion 566 of each of the spring portions 56 are accommodated in the receiving portion 342, the groove 344 and the margin portion 346 of the corresponding accommodation portion 34, respectively. Each of the margin portions 346 has an inner wall surface in the lateral direction which is far apart from an upper end of the upward extending portion 566 in the lateral direction. The thus-formed margin portion 346 allows a movement of the upward extending portion 566 in accordance with the resilient deformation of the spring portion 56.

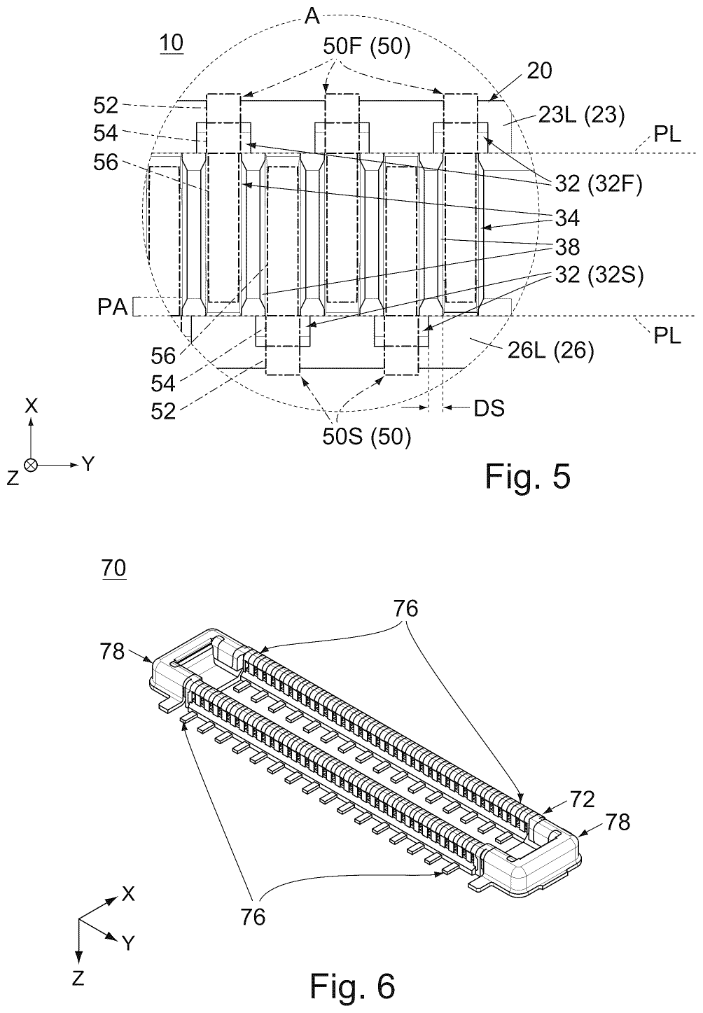

Referring to FIG. 4, the housing 20 of the present embodiment is formed with two first holding rows (holding rows) 32F and two second holding rows (holding rows) 32S. Each of the holding rows 32F and 32S is a row of the holding portions 32 and extends along the pitch direction. In other words, the holding portions 32 of each of the holding rows 32F and 32S are linearly arranged along the pitch direction. Referring to FIG. 5, each of the holding portions 32 of the first holding rows 32F holds the held portion 54 of the first terminal 50F. Each of the holding portions 32 of the second holding rows 32S holds the held portion 54 of the second terminal 50S.

Referring to FIG. 4, one of the two first holding rows 32F is formed in the left long wall 23L, and one of the two second holding rows 32S is formed in the left-side wall 26L of the island-like portion 26. A remaining one of the two first holding rows 32F is formed in the right-side wall 26R of the island-like portion 26, and a remaining one of the two second holding rows 32S is formed in the right long wall 23R.

The holding portions 32 of the first holding row 32F of the left long wall 23L and the holding portions 32 of the second holding row 32S of the left-side wall 26L hold the held portions 54 of the terminals 50 of one of the two terminal rows 50R, or the left-side terminal row 50R, respectively. The holding portions 32 of the first holding row 32F of the right-side wall 26R and the holding portions 32 of the second holding row 32S of the right long wall 23R hold the held portions 54 of the terminals 50 of a remaining one of the two terminal rows 50R, or the right-side terminal row 50R, respectively.

The housing 20 according to the present embodiment is formed with the two first holding rows 32F and the two second holding rows 32S. The thus-formed housing 20 can be provided with the two terminal rows 50R each extending linearly along the pitch direction. Thus, the number of the terminal rows 50R of the present embodiment is two. However, the present invention is not limited thereto. For example, the number of the terminal rows 50R may be one. In this instance, the number of the first holding rows 32F may be one, and the number of the second holding rows 32S may be one. For example, the island-like portion 26 may not be provided. In this instance, the left long wall 23L may be provided with the first holding row 32F, and the right long wall 23R may be provided with the second holding row 32S.

According to the present embodiment, each of the two long walls 23 and the two side walls 262 is formed with two or more of the holding portions 32. However, the present invention is not limited thereto. For example, each of the two long walls 23 and the two side walls 262 may be formed with only one of the holding portions 32. However, according to this instance, the size of the connector 10 in the pitch direction is only slightly reduced even when the pitch between the terminals 50 is made narrow. The present invention is suitable for the connector 10 with the two long walls 23 and the two side walls 262 each of which is formed with a large number of the holding portions 32.

The accommodation portions 34 of the present embodiment are divided into two rows which correspond to the two terminal rows 50R, respectively. The accommodation portions 34 of each row are linearly arranged along the pitch direction. However, the present invention is not limited thereto. For example, in an instance in which the number of the terminal rows 50R is one, the accommodation portions 34 may be arranged in a single line along the pitch direction.

Referring to FIG. 5, according to the present embodiment, any two of the accommodation portions 34 which are adjacent to each other in the pitch direction are located at positions substantially same as each other in the lateral direction. However, the present invention is not limited thereto. For example, two of the accommodation portions 34 which are adjacent to each other in the pitch direction may be located at positions at least partially same as each other in the lateral direction.

Referring to FIG. 5 together with FIGS. 7 and 8, any two of the accommodation portions 34 which are adjacent to each other in the pitch direction is formed with a partition wall 38 located therebetween. Each of the partition walls 38 is located between the receiving portions 342, the grooves 344 and the margin portions 346 of two of the accommodation portions 34 which are adjacent to each other so that two of the accommodation portions 34 which are adjacent to each other in the pitch direction are reliably insulated from each other. The pitch between the terminals 50 can be made narrow because the partition walls 38 are provided.

According to the present embodiment, every one of the holding portions 32 of the holding rows 32F and 32S is located at a position which is completely different from another position of any one of the accommodation portions 34 in the lateral direction and does not overlap with any one of the accommodation portions 34 in the lateral direction. Explaining this arrangement from another viewpoint, for any adjacent two of the terminals 50 which are adjacent to each other in the pitch direction, the holding portion 32 which holds the held portion 54 of one of the adjacent two of the terminals 50 does not overlap with the accommodation portion 34 which accommodates the spring portion 56 of a remaining one of the adjacent two of the terminals 50 in the lateral direction. More specifically, for each of the terminal rows 50R (see FIG. 4), the holding portion 32 which holds the held portion 54 of each of the first terminals 50F and the accommodation portion 34 which accommodates the spring portion 56 of each of the second terminals 50S are apart from each other so that they do not overlap with each other in the lateral direction. Similarly, for each of the terminal rows 50R, the holding portion 32 which holds the held portion 54 of each of the second terminals 50S and the accommodation portion 34 which accommodates the spring portion 56 of each of the first terminals 50F are apart from each other so that they do not overlap with each other in the lateral direction.

Referring to FIG. 5, in the explanation described below, adjacent two of the terminals 50 adjacent to each other in the pitch direction is also referred to as “adjacent terminals 50”. The holding portion 32 of the adjacent terminals 50 is apart from the accommodation portion 34 of a remaining one of the adjacent terminals 50 by a distance DS in the pitch direction. The distance DS becomes shorter as the pitch between the terminals 50 becomes narrower. If a position of the holding portion 32 of one of the adjacent terminals 50 and another position of the accommodation portion 34 of a remaining one of the adjacent terminals 50 overlap with each other in a predetermined area PA in the lateral direction, a path which is located in the predetermined area PA and through which resin flows becomes narrow, and thereby the partition walls 38 might be insufficiently formed during a molding process of the housing 20.

However, according to the present embodiment, a path through which resin flows during a molding process of the housing 20 can be sufficiently wide even when the pitch between the terminals 50 is made narrower. As a result, the partition wall 38 located between two of the accommodation portions 34 which are adjacent to each other in the pitch direction can be formed sufficiently thick, and thereby the housing 20 can be prevented from being degraded in strength. Thus, the present invention provides the connector 10 with a structure which enables the terminals 50 to be arranged in a narrower pitch.

According to the present embodiment, for each of the terminal rows 50R (see FIG. 4), the holding portion 32 which holds the held portion 54 of each of the first terminals 50F and the accommodation portion 34 which accommodates the spring portion 56 of each of the second terminals 50S are diagonally across from each other with a linear boundary (first boundary) located therebetween in the lateral direction. All the first boundaries of each of the terminal rows 50R are located on one predetermined line PL which extends along the pitch direction. Similarly, for each of the terminal rows 50R, the holding portion 32 which holds the held portion 54 of each of the second terminals 50S and the accommodation portion 34 which accommodates the spring portion 56 of each of the first terminals 50F are diagonally across from each other with a linear boundary (second boundary) located therebetween in the lateral direction. All the second boundaries of each of the terminal rows 50R are located on one predetermined line PL which extends along the pitch direction.

However, the present invention is not limited thereto. For example, in the lateral direction, a boundary of the holding portion 32 which holds the held portion 54 of the first terminal 50F may be apart from another boundary of the accommodation portion 34 which accommodates the spring portion 56 of the second terminal 50S. Similarly, in the lateral direction, a boundary of the holding portion 32 which holds the held portion 54 of the second terminal 50S may be apart from another boundary of the accommodation portion 34 which accommodates the spring portion 56 of the first terminal 50F. However, the present embodiment is preferable from a viewpoint of preventing increase of a size of the connector 10 in the lateral direction as possible.

Referring to FIG. 2, according to the present embodiment, the number of the terminals 50 of the right-side terminal row 50R is equal to the number of the terminals 50 of the left-side terminal row 50R. Each of the terminals 50 of the right-side terminal row 50R is located at a position same as that of one of the terminals 50 of the left-side terminal row 50R in the pitch direction. According to this arrangement, the connector 10 can be further reduced in a size in the pitch direction. However, the present invention is not limited thereto. For example, each of the terminals 50 of the right-side terminal row 50R may be located at a position which is different from that of any one of the terminals 50 of the left-side terminal row 50R in the pitch direction.

Referring to FIGS. 7 and 8, according to the present embodiment, each of the first terminals 50F of the right-side terminal row 50R is located at a position same as that of one of the first terminals 50F of the left-side terminal row 50R in the pitch direction, and each of the second terminals 50S of the right-side terminal row 50R is located at a position same as that of one of the second terminals 50S of the left-side terminal row 50R in the pitch direction. According to this arrangement, the fixed portions 52 of two of the terminals 50 which are located at positions same as each other in the pitch direction can be soldered to positions on the board 82 (see FIG. 3) which are far apart from each other, and thereby the terminals 50 can be prevented from being short-circuited. However, the present invention is not limited thereto. For example, each of the first terminals 50F of the right-side terminal row 50R may be located at a position same as that of one of the second terminals 50S of the left-side terminal row 50R in the pitch direction.

The present embodiment can be further variously modified in addition to the already described various modifications. For example, referring to FIG. 2, it is possible to visually inspect whether the fixed portions 52 are properly soldered on the board 82 (see FIG. 3) or not through the middle hole 27 with which the island-like portion 26 is formed according to the present embodiment. However, the present invention is not limited thereto. For example, the middle hole 27 may be formed as necessary.

What is claimed is:

1. A connector configured to be mounted on a board, wherein:
the connector comprises terminals and a housing;
each of the terminals has a fixed portion, a held portion, a spring portion and a contact point;
the fixed portion is configured to be fixed to the board;
the held portion extends from the fixed portion;
the spring portion extends from the held portion;
the contact point is supported by the spring portion;
the terminals are arranged along a pitch direction;
the fixed portions of adjacent two of the terminals which are adjacent to each other in the pitch direction are located at positions different from each other in a lateral direction perpendicular to the pitch direction;
the housing is formed with holding portions which correspond to the terminals, respectively, and accommodation portions which correspond to the terminals, respectively;
each of the holding portions holds the held portion of a corresponding one of the terminals;
each of the accommodation portions accommodates the spring portion of a corresponding one of the terminals;
the accommodation portions are arranged along the pitch direction;
two of the accommodation portions which are adjacent to each other in the pitch direction are formed with a partition wall located therebetween; and
the holding portion which holds the held portion of one of the adjacent two of the terminals does not overlap with the accommodation portion which accommodates the spring portion of a remaining one of the adjacent two of the terminals in the lateral direction.

2. The connector as recited in claim 1, wherein the fixed portion has a size in the pitch direction which is larger than another size of a spring portion in the pitch direction.
